(19) United States
(12) Patent Application Publication
(10) Pub. No.: US 2011/0087466 A1
(43) Pub. Date: Apr. 14, 2011

(54) METHOD AND APPARATUS FOR TRANSPARENTLY DISPLAYING INFORMATION RELATING TO DEVELOPMENT OF A MOTOR VEHICLE

(75) Inventor: Dirk Vossmann, Karlsruhe (DE)

(73) Assignee: Dr. Ing. h.c.F. Porsche Aktiengesellschaft, Stuttgart (DE)

(21) Appl. No.: 12/900,758

(22) Filed: Oct. 8, 2010

(30) Foreign Application Priority Data
Oct. 8, 2009 (DE) 10 2009 048 610.0

(51) Int. Cl. G06F 17/50

(52) U.S. Cl. 703/1

(57) ABSTRACT

A method is provided for rating and/or highlighting information in an image of a motor vehicle (12). Data relating to components of the motor vehicle (12) are displayed in the image together with a link (16) between the component and the associated data relating to the latter. The display is generated by a computer program (24) that links data relating to components of the motor vehicle (12) in a CAD model (11) of the motor vehicle (12) to data relating to the components in at least one database that is different from the CAD model (11). The linking is carried out so that individual components that satisfy a query criterion defined by a user are displayed in the image in highlighted form by the computer program (24).

### CROSS-REFERENCE TO RELATED APPLICATIONS

This application claims priority under 35 USC 119 to German Patent Application No. 10 2009 048 610.0 filed on Oct. 8, 2009, the entire disclosure of which is incorporated herein by reference.

### BACKGROUND OF THE INVENTION

1. Field of the Invention

The invention relates to a method, a computer program and a computer program product to enable a person involved in a vehicle development project to have a quick and intuitively understandable overview of information relevant to the project.

2. Description of the Related Art

A person responsible for a vehicle development project or a person involved in the vehicle development project should understand the project situation. In this context, “project situation” describes all information or a selection of information relevant to the project. Such information may be, for example, business management and/or technical information. Such images have previously been known in the form of manually produced innovation maps or project landscapes.

Analytical digital maps also are known. These maps link and display statements with reference to geographical locations. The statements may include economic variables, such as sales figures, construction activities or catchment radii of branches and subsidiaries.

With regard to the development of a vehicle, there repeatedly is a requirement for a transparent display of a project landscape, which is understood to mean a graphical overview of the above-mentioned information in conjunction with a display of the motor vehicle to be developed. The information changes at ever shorter intervals, particularly in the case of a complex project, such as the development of a motor vehicle. As a result, the manual creation and maintenance of such a project landscape becomes increasingly more difficult.

Against this background, an object of the invention is to specify a method that can be used to update the state of development at short intervals when developing a motor vehicle and, at the same time, to transparently display the state of development in an intuitively understandable form.

### SUMMARY OF THE INVENTION

The invention relates to a method and a computer program product that generates a display and that links data relating to components of the motor vehicle in a CAD model of the motor vehicle to data relating to the components in at least one database that is different from the CAD model. The linking process is carried out in such a manner that individual components that satisfy a query criterion defined by a user are displayed in the image in highlighted form by the computer program.

The linking of the CAD model to the data from other databases allows a display of relevant information from the other databases in association with the CAD data. The display can be created automatically and depicts the update status of the other databases without delay. As a result, a person responsible for development can be provided with a display of the state of development or individual aspects of the development of the project. The resulting display is always up to date, transparent and intuitively understandable.

The automatically created display is very flexible as a result of the possibilities provided by the CAD model. For example, zooming in and zooming out allow a rapid transition from an overview display to a very detailed display.

Further components can be added to a project during development and such further components can continuously concomitantly be included in the method. In this case, very different data can be acquired, preprocessed and linked to one another.

The invention is based on the consideration that a project for developing a vehicle is very dynamic and complex and gives rise to a multiplicity of very different data which may originate from very different data sources, possibly with different data formats. In this connection, the invention allows the multiplicity of development-related data to be acquired, linked and managed using a CAD model of a motor vehicle and to be made available to the employees involved in the project in a transparent manner, in an intuitively understandable structure, with up-to-date data and with little updating effort.

Possible components to which the data are linked are all components of the motor vehicle to be developed, such as mechanical, electrical or electromechanical parts that are depicted in the form of CAD data records in the CAD model and for which information exists in other databases, such as databases containing parts lists, SAP databases and so on. A link to planning data, which allow, for example, continuous deadline tracking from the smallest part to the finished vehicle or cost control, may also be made. Information for prioritizing parts, subassemblies or project steps can likewise be included.

Vehicle models that already exist can be incorporated in the method. For example, tried and tested components or parts of a vehicle can also be used for a vehicle to be currently developed. The description and display thereof can therefore be advantageously adopted.

Further advantages emerge from the claims, the description and the figures. All of the advantages emerge not only in connection with the method aspects but also in connection with the apparatus, computer program and computer program product aspects of the invention.

It goes without saying that the abovementioned features and the features still to be explained below can be used not only in the respectively stated combination but also in other combinations or alone without departing from the scope of the present invention.

Exemplary embodiments of the invention are illustrated in the drawings and are explained in the following detailed description.

### BRIEF DESCRIPTIONS OF THE DRAWINGS

FIG. 1 is an innovation map at its uppermost hierarchy level.

FIG. 2 is a function block diagram of method aspects and apparatus aspects of the present invention.

### DETAILED DESCRIPTION OF THE PREFERRED EMBODIMENT

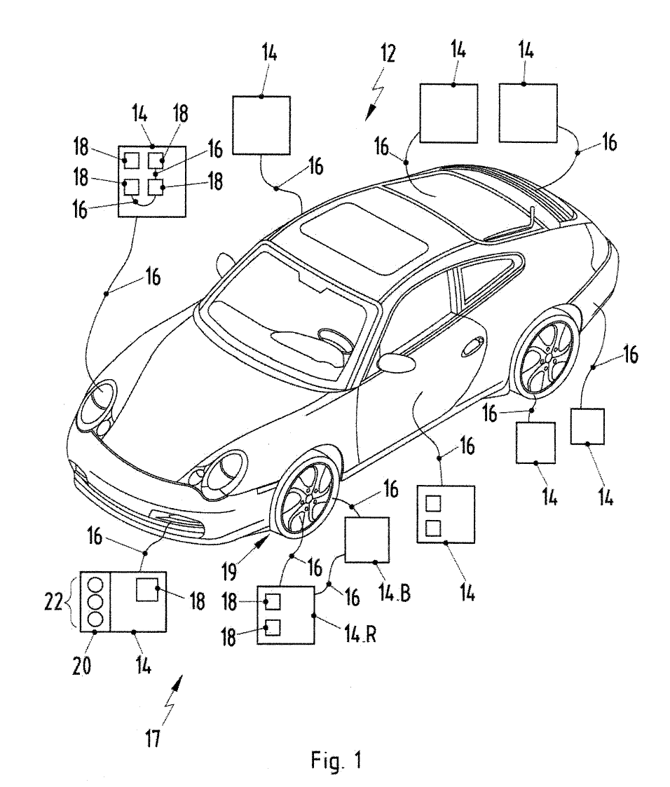

FIG. 1 is a screenshot for rating and/or highlighting information for a vehicle project at the uppermost hierarchy level. The image of a motor vehicle 12, surrounded by a multiplicity of information fields 14 associated with it, is displayed in the center.

A display on a screen has the advantage that no special media are needed to use the invention, beyond a screen at the user's workstation. It is also advantageous that the signals generated or used for the screen display can also be used for alternative or additional display using a projector.

The information and data managed within the scope of the invention and displayed in the information fields preferably are arranged in a tree-like structure in the image. Thus, the associations determined between the different components of the project can be illustrated for the observer in the display, for example by means of adjacent arrangements and/or by links or arrows.

The display is generated by a computer program that links data relating to components of the motor vehicle 12 to a plurality of databases that are different from a CAD model. In this case, the linking process is carried out so that individual components that satisfy a query criterion defined by a user are highlighted in the image by a computer program. In different refinements, the highlighting is effected by colored marking of the component and/or the associated information field 14 and/or by enlarging and extracting the image of the component and/or by displaying an indicator, such as a traffic-light display which, for example when red, signals a particular need for action in the case of this component.

The information fields 14 are related visually to the associated components of the motor vehicle 12 by means of links 16. The information fields 14 and the links 16 preferably are arranged in the spatial vicinity of the associated components. At the uppermost hierarchy level depicted, the information fields 14 are arranged at a distance from one another and/or above one another, the arrangement preferably is selected so that the entire image area is used in an approximately uniform manner. As a result, the information is displayed clearly on a screen 17 in a manner that can be understood intuitively by the observer. Subordinate information fields 18 from underlying hierarchy levels are sometimes also visible, the functional association of which likewise is rendered visible by links 16 and arrows. Where apparently expedient, components of the uppermost hierarchy level may also refer to one another by means of associated arrows. For example, an association between the information fields 14.R and 14.B for a wheel 19 and its braking apparatus may be displayed by means of a link 16.

The information fields 14 can have diverse configurations and may contain: alphanumeric fields for outputting and inputting data, tables, bar charts, buttons, indicators, window bars, bars for vertical or horizontal movement (so-called scroll bars), borders, markings, links 16 and/or arrows. This list is not intended to be conclusive. The elements of the information fields 14 can be controlled interactively by a user by an input means, such as a keyboard or a mouse. All of the hierarchy levels defined for a respective component and its associated information fields 14, 18 therefore can be addressed. As a result, a component gradually can be broken up into the smallest subcomponent. In this case, data of all types can be read in and/or written and/or displayed if necessary provided that the user has specific authorization.

Components or information fields 14 can be highlighted by clicking on them with a mouse pointer or cursor, or merely moving a mouse pointer or cursor over the components or information fields. Depending on the configuration, this is effected by colored marking of the information field 14 and/or by enlarging and/or extracting the image of the component and/or displaying an indicator 20, for example traffic lights 22, associated with the component.

The practice of enlarging and extracting a component from its environment in the image allows the information relating to the component to be displayed in full and over a large area. For example, the component originally may be displayed only in the form of a symbol and, after it has been highlighted, may assume the properties of a screen window, as known, for example, from PC programs. In this case, other components may be covered temporarily, if necessary. It is possible to navigate in the component that has been marked or enlarged in this manner, for example using a keyboard or a PC mouse. As a result the respective (window) contents can be moved horizontally or vertically, or subwindows that have even more details of a component can be opened using buttons. It is likewise possible to permanently or temporarily depict individual components or a plurality of components in the form of an exploded illustration.

Depending on the refinement, the practice of highlighting using an indicator is carried out in addition or as an alternative to the other highlighting. Such an indicator, for example an additionally displayed simple symbol, can be used, for example to apply component-specific markings or trigger warnings.

An indicator 20 in the form of traffic lights 22 is illustrated by way of example in FIG. 1, at one component or information field 14 or at a subordinate information field 18 at the bottom left of the drawing. The indicator provides intuitively understandable and meaningful information on an urgency gradation. In one refinement, the display of the traffic lights represents whether there is a need for action in connection with the component. This provides a quick and reliable overview of possible temporary problems during the vehicle project. More particularly, it is possible to distinguish easily between urgent (red) and less urgent (yellow) or scheduled (green) components when multiple components are depicted at the same time. Thus, the display is improved overall.

In one refinement, the indicator 20 is generated or activated as a response to a query that is triggered by means of a mouse click, by moving a cursor over the component display or by means of another input medium. Alternatively or additionally, another refinement provides for the indicator to be generated and displayed by a computer program independently of a request by the user. In such a case, the indicator is generated, for example, in the form of a so-called pop-up element that is visible continuously or for a limited time for one information field 14, for a plurality of information fields 14 or for all information fields 14 or subordinate information fields 18. It is thus possible to decide whether there is an urgent need for action for any desired component.

The invention may allow both the display of the image and the underlying contents to be changed. For example, displayed symbols can be arranged permanently in a different manner or components can be added, changed or deleted. Access authorization preferably is provided for this purpose so that only authorized employees can make such changes.

A report function can be provided and can be triggered using a so-called report button. The report function can be used in diverse ways, for example, to display or write project reports. The report function may allow the triggering of a query that includes all subprojects, and the display of costs and/or states of development and/or a different comparison of properties of the project that need to be displayed.

The entire vehicle project represented by the CAD model may be implemented physically by an apparatus 26 in the form of a computer. The apparatus has at least one processor and at least one memory. The apparatus can also be implemented as a network of plural standalone computers, individual computers of which manage individual databases and communicate with one another via a bus system. For the rest, the apparatus 26 is set up or programmed to carry out the method of the invention.

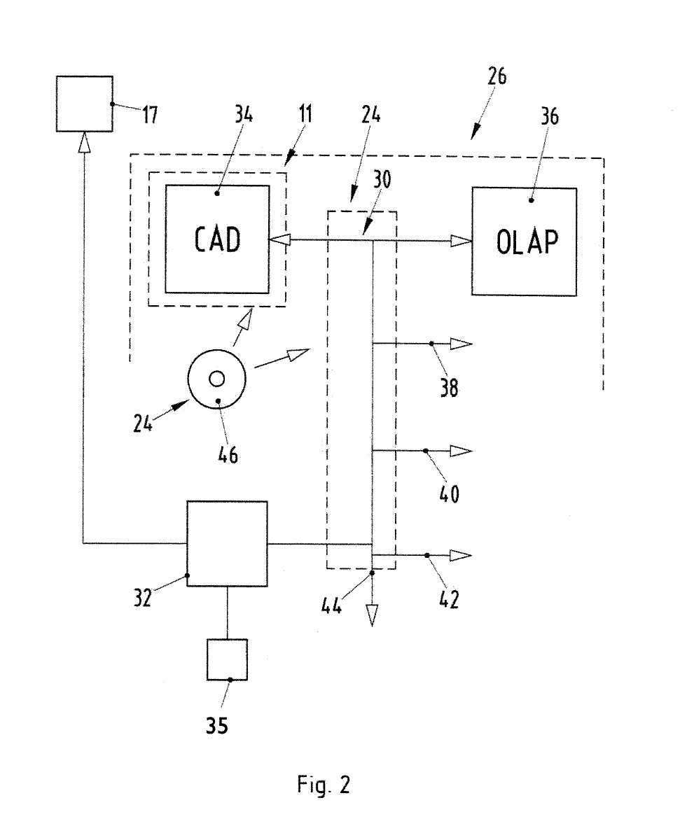

FIG. 2 shows signal processing structures of the apparatus 26 and illustrates both method and apparatus aspects of the invention. In detail, FIG. 2 shows a program module or information framework 30 that depicts a tree-like structure via which different databases 36 are connected to a CAD model 11 or to a CAD database 34 for the motor vehicle 12 and to at least one processor 32. The information framework 30 is incorporated in a computer program 24 or can at least be addressed and used by the computer program 24. The top left of the drawing illustrates the CAD database 34 that is connected to an OLAP (On-Line Analytical Processing) database 36 at the top right. In this case, an OLAP database is understood as meaning a multidimensional database for managing business management or statistical data stocks and allows data to be queried in a multidimensional manner and allows data to be written back. It is to be appreciated that CAD model 11, CAD database 34 and databases 36 are stored in the at least one memory of the apparatus 26 or among several memories of the individual computers of the network of plural standalone computers.

The processor 32 uses the information framework 30, which depicts hardware and software structures, to access the different components 11, 34, 36, 38, 40, 42, 44. The processor 32 then cooperates with the computer program 24 to generate a display of the motor vehicle 12 and the project information relating to the motor vehicle 12 on the screen 17, as was described further above in connection with FIG. 1. An input means 35 allows a user to input information, such as data and/or commands.

On the basis of this connection, it is possible to reach further databases and/or computer systems in a bidirectional manner. A data path 38 allows a SAP system to be connected, another data path 40 connects a parts list information system, and a data path 42 allows other expansions. A data path 44 allows the use of local or global networks, including a connection to the worldwide Internet.

This makes it possible to use a wide variety of databases and systems interactively with the CAD model 11 to rate or highlight information in connection with a vehicle development project.

A computer program product 46 contains the computer program 24, on which FIGS. 1 and 2 are based and implements the CAD model 11. The computer program product 46 may be distributed to one or more data storage media and has a computer program 24 in machine-readable form which includes instructions executable by the computer or machine to perform the method described above in connection with FIGS. 1 and 2. This may be, for example, a data storage medium in the form of a CD (compact disk), a DVD (digital versatile disk) or a USB memory (so-called USB stick). As a result, the method essential to the invention may have been designed as a computer program that advantageously can be stored on a medium and can be easily installed, if necessary, on a computer, for example a CAD workstation or a PC.

What is claimed is:

1. A method for using a computer and a computer program to rate or highlight information relating to a motor vehicle, comprising:
displaying on the computer at least one image of at least one part of a motor vehicle using a model of the motor vehicle;
providing data relating to the motor vehicle in at least one database that is different from the CAD model;
providing a link between the CAD model and the at least one database that is different from the CAD model;
using the computer program to generate a display that links data relating to components of the motor vehicle in the CAD model of the motor vehicle to the data from the at least one database that is different from the CAD model; and
using the computer program to display or highlight individual components that satisfy a query criterion defined by a user.

2. The method of claim 1, wherein the display is effected on a screen.

3. The method of claim 1, wherein the highlighting is effected by colored marking of a queried component.

4. The method of claim 1, wherein the highlighting is effected by depicting an indicator.

5. The method of claim 4, wherein the indicator is displayed in the form of traffic lights with a display that signals whether there is a need for action in connection with the component.

6. The method of claim 1, wherein the highlighting is effected by enlarging and extracting the image of the component from the image of its vehicle environment.

7. An apparatus for rating or highlighting information in an image of a motor vehicle, the apparatus comprising:
at least one image of at least one part of a motor vehicle from a CAD model of the motor vehicle;
data relating to the motor vehicle in at least one database that is different from the CAD model; and
at least one processor that displays and links data relating to components of the motor vehicle in the CAD model of the motor vehicle to the data relating to the components in at least one database that is different from the CAD model, the at least one processor further displays individual components that satisfy a query criterion defined by a user in the image in highlighted form.

8. The apparatus of claim 7, wherein the highlighting is effected by colored marking of a queried component.

9. The apparatus of claim 7, wherein the highlighting is effected by depicting an indicator.

10. The apparatus of claim 9, wherein the indicator is displayed in the form of traffic lights with a display that signals whether there is a need for action in connection with the component.

11. The apparatus of claim 7, wherein the highlighting is effected by enlarging and extracting the image of the component from the image of its vehicle environment.

12. A computer program product readable by a machine, tangibly embodying a program of instructions executable by the machine to perform method steps to rate or highlight information relating to a motor vehicle, the method comprising:
displaying on the computer at least one image of at least one part of a motor vehicle using a CAD model of the motor vehicle;
providing data relating to the motor vehicle in at least one database that is different from the CAD model;
providing a link between the CAD model and the at least one database that is different from the CAD model;
using the computer program to generate a display that links data relating to components of the motor vehicle in the CAD model of the motor vehicle to the data from the at least one database that is different from the CAD model; and
using the computer program to display or highlight individual components that satisfy a query criterion defined by a user.

13. The computer program product of claim 12, wherein the highlighting is effected by colored marking of a queried component or by enlarging and extracting the image of the component from the image of its vehicle environment.

14. The computer program product of claim 12, wherein the highlighting is effected by depicting an indicator.

15. The computer program product of claim 14, wherein the indicator is displayed in the form of traffic lights with a display that signals whether there is a need for action in connection with the component.

16. The computer program product of claim 12, wherein the highlighting is effected by enlarging and extracting the image of the component from the image of its vehicle environment.
